(19) United States
(12) Patent Application Publication
(10) Pub. No.: US 2024/0424873 A1
(43) Pub. Date: Dec. 26, 2024

(54) CONTEXTUAL ADAPTATION OF VEHICULAR DIMMABLE GLASS

(71) Applicant: GM GLOBAL TECHNOLOGY OPERATIONS LLC, DETROIT, MI (US)

(72) Inventors: Alaa M. Khamis, Courtice (CA); Yujie Guo, Thornhill (CA); Brooke Lynn Waldon, Romulus, MI (US); Julien P. Mourou, Bloomfield Hills, MI (US); Jarvis Cahu, Markham (CA)

(21) Appl. No.: 18/339,425

(22) Filed: Jun. 22, 2023

(51) Int. Cl. B60J 3/04; G02F 1/163; G07C 5/02

(52) U.S. Cl. CPC B60J 3/04; G02F 1/163; G07C 5/02

(57) ABSTRACT

Some embodiments disclosed herein are directed to controlling tinting levels of dimmable glass on vehicles. Other embodiments may be disclosed or claimed.

### INTRODUCTION

The subject disclosure relates to control systems for dimmable glass on vehicles. In particular, embodiments of the present disclosure relate to dynamically controlling tint levels of vehicular glass based on contextual data associated with the vehicle.

For decades, vehicle glass (e.g., windshields, sunroofs, windows) has been tinted to help provide better visibility in bright conditions and other uses. Such tinting typically includes applying a thin layer of tinting material to the glass to provide a static tinting level for the glass. Increasingly, modern vehicles utilize dimmable glass. Dimmable glass typically includes an electrochromic layer between two glass layers. The electrochromic layer can be electrically controlled to adjust the level of tinting for the dimmable glass, thereby allowing the glass to provide, for example, a darker level of tinting in bright conditions and a lighter level of tinting in darker conditions.

Embodiments of the present disclosure provide control systems with enhanced capabilities to dynamically adjust the tinting levels of vehicular dimmable glass, in real-time or near-real-time, based on context data inputs associated with the vehicle. Among other things, embodiments of the present disclosure improve the efficiency and effectiveness of dimmable glass control systems, thereby improving their overall functionality.

### SUMMARY

In one exemplary embodiment, a control system for a vehicle is provided. The control system comprises a processor and memory coupled to the processor. The memory stores instructions that, when executed by the processor, cause the control system to retrieve a plurality of context data inputs associated with the vehicle. In some embodiments, the context data inputs include location information for the vehicle, such as type information for the vehicle, a driving mode of the vehicle, an ambient condition for the vehicle, and a user preference associated with the vehicle. The memory further stores instructions to cause the control system to determine, based on the context data inputs, a tint value for a portion of dimmable glass coupled to the vehicle. In some embodiments, determining the tint value includes determining a respective weighted visible light transmission value for each respective context data input in the plurality of context data inputs. The memory further stores instructions to generate a command to control the portion of dimmable glass that includes the determined tint value, and to transmit the command to a dimming controller coupled to the portion of dimmable glass to control a tinting level of the portion of dimmable glass according to the determined tint value.

In addition to one or more of the features described herein, determining the tint value for the portion of dimmable glass includes determining, based on the location information for the vehicle, a regulation limiting an upper bound or lower bound of the determined tint value. In some embodiments the regulation limits the tint value to a fixed value.

In addition to one or more of the features described herein, determining the tint value for the portion of dimmable glass is further based on dividing an intermediate tint value by a refinement factor, wherein the refinement factor is an integer value greater than one.

In addition to one or more of the features described herein, the ambient condition for the vehicle may include, for example, a sun azimuth level and/or a sun intensity level. In some embodiments, the ambient condition for the vehicle includes, for example, a temperature level and/or a humidity level. In some embodiments, the ambient condition for the vehicle includes a safety level determined based on the location information for the vehicle. In some embodiments, the ambient condition for the vehicle includes a time of day.

In addition to one or more of the features described herein, the ambient condition for the vehicle is retrieved from a sensor coupled to the vehicle, wherein the sensor includes, for example, a thermometer, a hygrometer, a light level sensor, and/or a motion sensor.

In addition to one or more of the features described herein, the type information for the vehicle includes an indication of a number and configuration of a plurality of dimmable glass portions coupled to the vehicle.

In addition to one or more of the features described herein, the driving mode of the vehicle includes an indication of for example, a speed of the vehicle, a direction of travel of the vehicle, and/or an indication of whether the vehicle is moving forward or in reverse.

In addition to one or more of the features described herein, the user preference associated with the vehicle indicates an upper bound and a lower bound for the determined tint value.

In addition to one or more of the features described herein, a plurality of portions of dimmable glass are coupled to the vehicle, and wherein the memory further stores instructions to cause the control system to determine, based on the context data inputs, a respective tint value for each respective portion of dimmable glass coupled to the vehicle.

In addition to one or more of the features described herein, the generated command includes the respective tint value for each respective portion of dimmable glass.

In addition to one or more of the features described herein, the memory further stores instructions to generate and transmit a plurality of commands, wherein each respective command is associated with a respective portion of dimmable glass that includes the respective tint value for the respective portion of dimmable glass.

In addition to one or more of the features described herein, the plurality of portions of dimmable glass include a windshield, a front portion, and a back portion.

In addition to one or more of the features described herein, the front portion is a front driver-side portion, and the plurality of portions of dimmable glass further includes a front passenger-side portion.

In addition to one or more of the features described herein, a tint value for a first portion of dimmable glass from the plurality of portions of dimmable glass is different from a tint value for a second portion of dimmable glass from the plurality of portions of dimmable glass.

In one exemplary embodiment a dimming control system for a vehicle is provided. The dimming control system comprises a processor and memory coupled to the processor. The memory stores instructions that, when executed by the processor, cause the dimming control system to retrieve a plurality of context data inputs associated with the vehicle. In some embodiments, the context data inputs include location information for the vehicle and type information for the vehicle, a driving mode of the vehicle, an ambient condition for the vehicle, and/or a user preference associated with the vehicle. The memory further stores instructions to determine, based on the context data inputs, a tint value for a portion of dimmable glass coupled to the vehicle, wherein determining the tint value includes determining a respective weighted visible light transmission value for each respective context data input in the plurality of context data inputs. The memory further stores instructions to control a tinting level of the portion of dimmable glass according to the determined tint value.

In one exemplary embodiment, a vehicle is provided, the vehicle comprising: a portion of dimmable glass; and a dimming control system coupled to the portion of dimmable glass. The dimming control system includes a processor and memory coupled to the processor and storing instructions that, when executed by the processor, cause the dimming control system to retrieve a plurality of context data inputs associated with the vehicle. In some embodiments, the context data inputs include location information for the vehicle and type information for the vehicle, a driving mode of the vehicle, an ambient condition for the vehicle, and/or a user preference associated with the vehicle. The memory further stores instructions to determine, based on the context data inputs, a tint value for the portion of dimmable glass. In some embodiments, determining the tint value includes determining a respective weighted visible light transmission value for each respective context data input in the plurality of context data inputs. The memory further stores instructions to control a tinting level of the portion of dimmable glass according to the determined tint value.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A is a schematic diagram of a vehicle for use in conjunction with embodiments of the present disclosure;

FIG. 1B is another schematic diagram of the vehicle in FIG. 1A in accordance with embodiments of the present disclosure;

FIG. 2 is a functional block diagram illustrating a control system for a vehicle in accordance with embodiments of the present disclosure;

FIG. 3 is an example of a flow diagram illustrating a process in accordance with embodiments of the present disclosure; and

FIG. 4 is an example of a flow diagrams illustrating another process in accordance with embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a control system for portions of dimmable glass coupled to a vehicle is provided. The control system may determine a tint value for a portion of dimmable glass based on context data inputs associated with the vehicle, such as one or more of: location information for the vehicle, type information for the vehicle, a driving mode of the vehicle, a measured ambient condition for the vehicle, and a user preference associated with the vehicle. Among other things, embodiments of the disclosure help dynamically modify the tint level of the dimmable glass without manual intervention by a user, thereby improving the efficiency and performance of dimmable glass system in the vehicle.

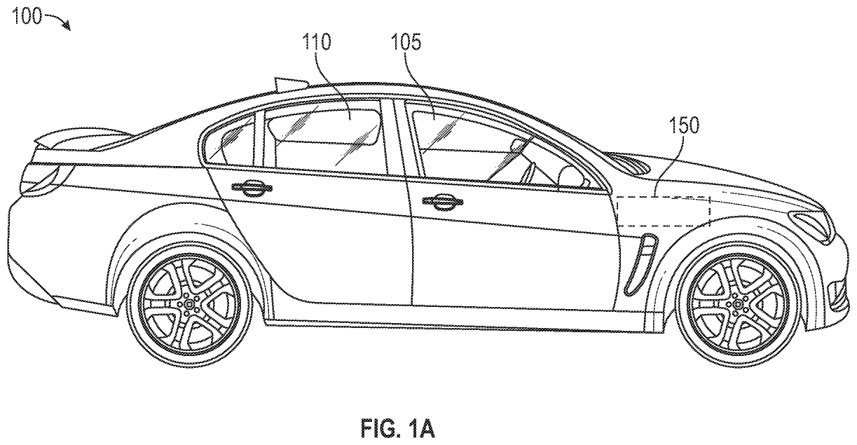

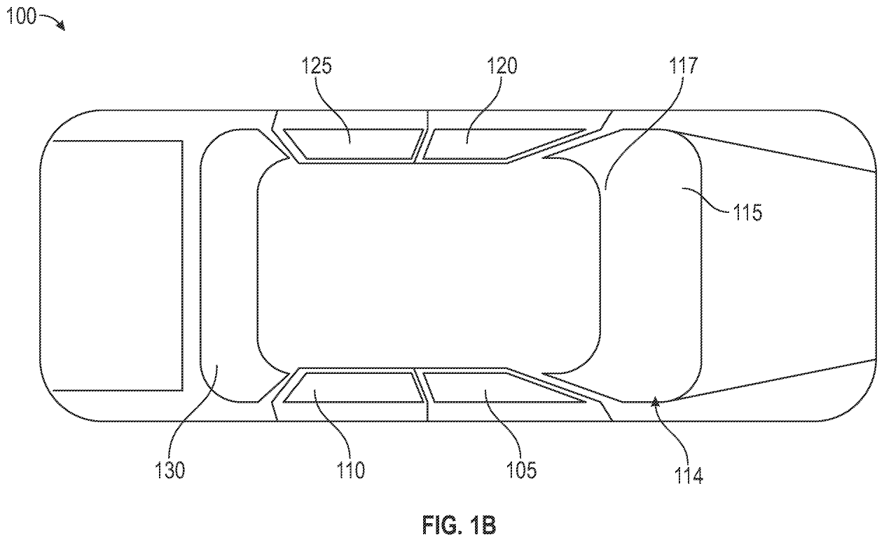

Referring now to FIG. 1A, a schematic diagram of a vehicle 100 for use in conjunction with one or more embodiments of the present disclosure is shown. This view of vehicle 100 shows a first portion of dimmable glass 105 (the front passenger side window) and a second portion of dimmable glass 110 (the rear passenger side window). The dimmable glass portions 105, 110 are coupled to a control system 150 for controlling the tint level of the respective portions of dimmable glass. FIG. 1B provides a top view of vehicle 100 illustrating additional portions of dimmable glass coupled to the vehicle 100. In this example, vehicle 100 is coupled to a windshield 114 that includes a lower portion of dimmable glass 115 for the main windshield and a portion of dimmable glass 117 along the top of the windshield 114 acting as a dimmable glass visor. In this example, the windshield 114 can provide different tinting levels in the visor 117 and the main windshield 115 to help shield a user's eyes from sunlight.

As further shown in FIG. 1B, vehicle 100 additionally includes dimmable glass portions 120 (the front driver side window), 125 (the rear driver side window) and 130 (rear window). In alternate embodiments, a vehicle may have more or fewer dimmable glass portions, and not all glass on a vehicle need necessarily be dimmable. In some embodiments, the control system 150 may independently control the tinting level of each separate portion of dimmable glass, such that each portion may have a different tinting level. Alternatively, the control system 150 may control two or more portions of dimmable glass on the vehicle to have the same tinting level.

In some exemplary embodiments, the control system 150 includes at least one processor, such as a general processor, a central processing unit, an application-specific integrated circuit (ASIC), a digital signal processor, a field-programmable gate array (FPGA), a digital circuit, an analog circuit, or combinations thereof. In some embodiments, the control system 150 includes a memory in communication with the processor to store data and instructions executable by the processor to retrieve context data input from various sensors on the vehicle (and other sources) and generate commands to control portions of dimmable glass on the vehicle.

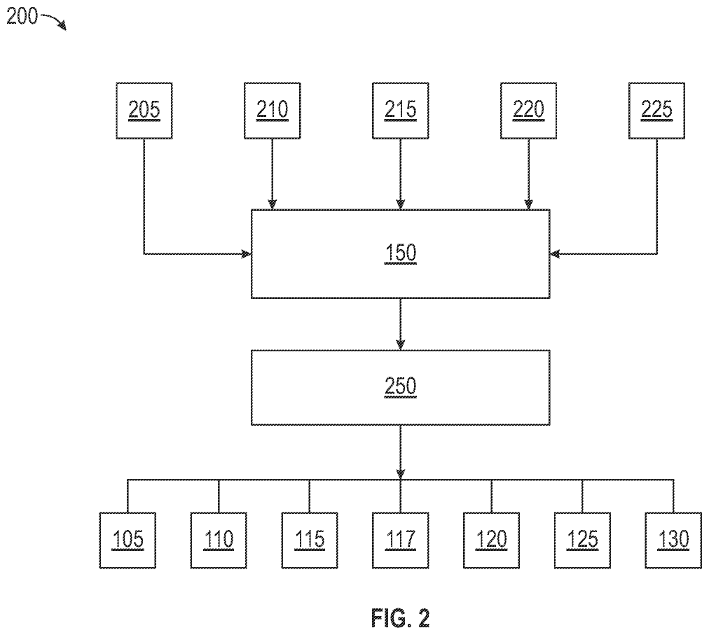

Embodiments of the present disclosure may be implemented by control system 150 controlling the tinting level of the dimmable glass portions of a vehicle directly, or by sending commands to one or more intermediary devices, such as a dimming controller. For example, FIG. 2 illustrates an example of a functional block diagram 200 including control system 150 coupled to a dimming controller 250 for controlling the portions of dimmable glass of vehicle 100. In some embodiments, the control system 150 may communicate with a separate dimming controller coupled to each portion of dimmable glass on a vehicle. In other embodiments, such as the example shown in FIG. 2, control system 150 may communicate with a single dimming controller 250 that controls all of the dimmable glass portions 105, 110, 115, 117, 120, 125, and 130 on vehicle 100. Still other configurations are possible in alternate embodiments.

In the example depicted in FIG. 2, diagram 200 illustrates control system 150 receiving context data inputs including location information for the vehicle 205, type information for the vehicle 210, driving mode information for the vehicle 215, one or more ambient conditions associated with the vehicle 220, and one or more user preferences associated with the vehicle 225.

In the exemplary diagram 200 shown in FIG. 2, the context data input features 205, 210, 215, 220, and 225 may be implemented in conjunction with lookup tables stored in the memory of control system 150. Such lookup tables may include pre-stored values associated with each respective context data input to help facilitate faster data retrieval by control system 150. Additionally or alternatively, the control system 150 may retrieve data associated with a context data input (e.g., from a sensor coupled to the vehicle or other source) in real time or near-real time.

In the example depicted in FIG. 2, the location information for the vehicle 205 may include information retrieved from a global positioning sensor (GPS) coupled to the vehicle or in communication with the vehicle, such as a GPS system on a mobile device of a user of the vehicle. Location information 205 may also be retrieved or determined based on data from other sources, such as from cell site location information (CSLI) retrieved from adjacent cellular network towers.

The type information for the vehicle 210 may include details such as the vehicle's make, model, manufacturer, and other information. The vehicle type information 210 may include an indication of a number and configuration of a plurality of dimmable glass portions coupled to the vehicle.

The driving mode information for the vehicle 215 may include any suitable information regarding whether or how the vehicle is currently being driven. For example, driving mode information 215 may include an indication of one or more of: a speed of the vehicle, a direction of travel of the vehicle, and an indication of whether the vehicle is moving forward or in reverse. In some embodiments, driving mode information 215 may be derived by the control system 150 based on other context data input information. For example, the location information 205 may be used in conjunction with speed information from an onboard sensor on the vehicle to determine the vehicle is traveling East on a freeway.

The ambient condition information for the vehicle 220 may include any suitable information related to conditions inside or outside the vehicle, as well as within a predetermined distance to the vehicle. For example, the ambient condition for the vehicle 220 may include one or more of: a sun azimuth level, a sun intensity level, a temperature level, a humidity level, weather conditions (e.g., rain, fog) within a predetermined distance of the vehicle, and a time of day in the time zone where the vehicle is located.

In some embodiments, the ambient condition information 220 may be measured directly from sensors coupled to the vehicle, or from other data sources. For example, the ambient condition information 220 may include data from a thermometer, a hygrometer, a light level sensor, or a motion sensor.

In some embodiments, the ambient condition information for the vehicle 220 may include information based on other context data input information. For example, the ambient condition for the vehicle 220 may include a safety level that is determined by the control system 150 based on the location information for the vehicle 205.

The user preference information 225 may include various settings associated with the tinting level of the dimmable glass portions of the vehicle. For example, in some embodiments the user preference associated with the vehicle 225 indicates an upper bound and a lower bound for a tint value of a portion of dimmable glass on the vehicle 100.

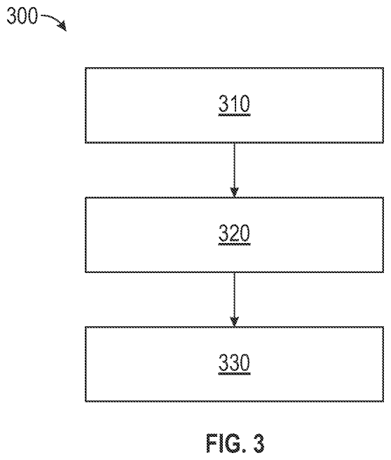

FIG. 3 illustrates an example of a process that may be performed in accordance with various embodiments. In this example, process 300 includes, at 310, determining a number and configuration of portions of dimmable glass for a vehicle based on type information for the vehicle 210. For example, FIG. 1A and FIG. 1B illustrate an example of dimmable glass for an exemplary passenger car. The vehicle type information 210 further indicates the configuration of each portion of dimmable glass, such as its size, shape, and information regarding the interface and control of the electrochromic properties of the glass. A truck or sport utility vehicle might include more or fewer portions of dimmable glass, with different shapes and sizes of each. In some cases, not all glass in a vehicle may be dimmable (e.g., just the windshield and back window).

Based on the dimmable glass portions and their properties determined in 310, process 300 further includes, at 320, performing a weighted averaging process to determine a tint value for one or more portions of the dimmable glass. In the example in FIG. 3, a single tint value Tₐᵤₜₒ is generated to apply to each portion of dimmable glass on the vehicle. The tint value Tₐᵤₜₒ and each component T-value (T_{safety}, T_{vehicle}, etc.) represent values of visible light transmittance (VLT). In one example, the value of Tₐᵤₜₒ may be determined based on weighted averages for the retrieved context data input features 205, 210, 215, 220, and 225 according to:

$$T\_auto = {ω}_{safety} \times {T}_{safety} + {ω}_{vehicle} \times {T}_{vehicle} + {ω}_{sun} \times {T}_{sun} + {ω}_{weather} \times {T}_{weather} + {ω}_{preferred} \times {T}_{preferred}$$

Where:
T_{safety} is a safety tinting value based on location information 205 and ambient condition information 220 such as time of day;
T_{vehicle} is a tinting value based on the vehicle type information 210 and driving mode information 215;
Tₛᵤₙ is a tinting value based on sun intensity and sun azimuth determined based on location information 205 and ambient condition information 220 (e.g., from light sensors coupled to the vehicle);
T_{weather} is a tinting value based on weather conditions determined from the ambient condition information 220; and
T_{preferred} is a tinting value based on the user preference information 225.

In the preceding equation, a respective weight ω is assigned to each respective tinting value to reflect the level of importance of the respective tinting value. The ω values reflect percentages and sum together to equal 1. For instance, exemplary values for the respective weights in the preceding equation could be:

ω_{safety}=0.3; ω_{vehicle}=0.1; ωₛᵤₙ=0.2; ω_{weather}=0.2; and ω_{preferred}=0.2.

In some embodiments, the Tₐᵤₜₒ tint value may be determined based on a refinement factor. For example, the refinement factor may include any integer greater than 1 and may be used to generate various tint levels based on different variables. In some embodiments, the refinement factor may be adjusted by the control system 150 based on input from a user.

Process 300 further includes, at 330, applying a threshold process to the Tₐᵤₜₒ tint value to ensure the tint value is within appropriate thresholds. In some embodiments, the threshold may be based on a regulation associated with a current location of the vehicle. For example, in some embodiments different portions of dimmable glass may have upper and lower bounds dictated by law or regulation for a region in which the vehicle is located.

In a particular example, the windshield 115 and front windows 105, 120 of vehicle 100 may have a lower bound threshold of 20% and an upper bound threshold of 70% enforced by local and regional laws for a vehicle in a particular location. In the same example, the visor portion 117, rear windows 110, 125, and back window 130 may have a lower bound threshold of 0.01% and an upper bound threshold of 70%. In this example, the control system 150 may increase the tinting level of all dimmable glass on the vehicle up to 70%, but the thresholding process will prevent the tinting value from dropping below 20% for the windshield 115 and front windows 105, 120. In some embodiments, the control system may set the window tinting level of one or more portions of dimmable glass on the vehicle to a fixed value based on determined laws or regulations for the location of the vehicle 100.

In this manner, embodiments of the present disclosure can help ensure that a user of vehicle 100 complies with applicable laws and regulations regarding window tinting, even if the driver is unaware of such requirements. Moreover, the control system 150 can adjust tinting levels of dimmable glass in a vehicle in real-time or near-real time to accommodate such laws and regulations in response to the vehicle 100 passing over a regional boundary, without intervention from the user.

The tint value applied to a portion of dimmable glass in accordance with embodiments of the present disclosure may be manually overridden by a user (e.g., driver of the vehicle). The automatic tint determination features of embodiments of the present disclosure may likewise be disabled (temporarily or indefinitely) by the user. In some embodiments, features of the control system 150 may be accessed, modified, or disabled by an external user, such as a remote representative providing customer service for the vehicle or user of the vehicle. In other embodiments, a law enforcement officer can interact with the control system 150 vehicle through an interface to control the level of tinting for portions of dimmable glass.

In some embodiments, the control system 150 may determine or adjust the tint value for a portion of dimmable glass on the vehicle 100 based on drive mode information 215 indicating state information associated with autonomous control of the vehicle. For example, in some embodiments drivers in autonomous vehicles do not need to constantly monitor road conditions, therefore the upper and lower bounds for all window glass can be the same, such as ranging from 0.01% to 70%. In this example, accordingly, the front windows 105, 120 and windshield 115 can have the same tint levels as the other windows 110, 125, 130.

In some embodiments, the control system 150 may determine or adjust the tint value for a portion of dimmable glass on the vehicle 100 based on a predicted score associated with lux-level comfort and safety. For example, the control system may determine lux level comfort predicted score based on a level of illuminance (lux) from a light sensor coupled to the vehicle 100. The control system 150 may determine a predicted anti-glare safety score based on time of day and location information from the context data input information.

Based on the lux level comfort predicted score and the predicted anti-glare safety score, the control system 150 may generate a lux comfort and safety combined predicted score. The lux comfort and safety combined predicted score may be adjusted based on user input associated with a range of illumination preferred by the user (e.g., 2000-6000 lux) and used to adjust the tint value for portions of dimmable glass in the vehicle 100 to help attain the user's preferred level of illumination while still meeting legal/regulatory requirements.

In some embodiments, ambient lux can be estimated using a data-driven model that takes as an input data from existing vehicle sensors (such as an ambient light sensor, an HUD light sensor, a display light sensor and other light sensors) and produces estimated ambient lux as output. In other embodiments, the control system 150 may combine the vehicle sensory data using a weighting scheme and giving more weight to the ambient light sensor relative to other sensors.

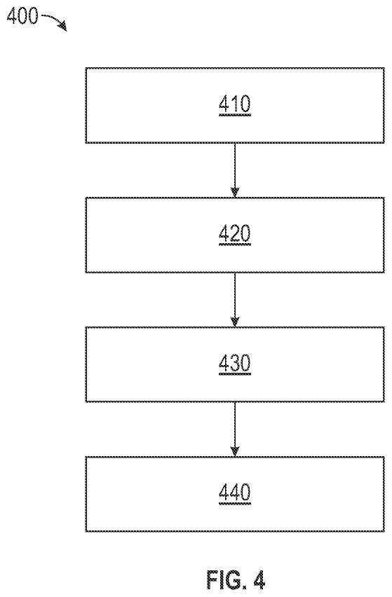

FIG. 4 illustrates yet another example of a process that may be performed in accordance with various embodiments. The process 400 in FIG. 4 may be performed by any suitable device or combination of devices, such as by a processor of control system 250 executing computer-readable instructions stored in a memory of the control system 250.

In this example, process 400 includes, at 410, retrieving context data inputs associated with the vehicle. As noted herein, the context data inputs may include one or more of: location information for the vehicle, type information for the vehicle, a driving mode of the vehicle, an ambient condition for the vehicle, and a user preference associated with the vehicle.

Process 400 further includes, at 420, determining, based on the context data, a tint value for a portion of dimmable glass coupled to the vehicle. In some embodiments, determining the tint value includes determining a respective weighted visible light transmission value for each respective context data input in the plurality of context data inputs.

Process 400 further includes, at 430, generating a command to control the portion of dimmable glass that includes the determined tint value. Process 400 further includes, at 440, transmitting the command to a dimming controller (such as dimming controller 250 in FIG. 2) coupled to the portion of dimmable glass to control a tinting level of the portion of dimmable glass according to the determined tint value.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A control system for a vehicle, the control system comprising:
a processor; and
memory coupled to the processor and storing instructions that, when executed by the processor, cause the control system to:
retrieve a plurality of context data inputs associated with the vehicle, wherein the context data inputs include location information for the vehicle and one or more of: type information for the vehicle, a driving mode of the vehicle, an ambient condition for the vehicle, and a user preference associated with the vehicle;
determine, based on the context data inputs, a tint value for a portion of dimmable glass coupled to the vehicle, wherein determining the tint value includes determining a respective weighted visible light transmission value for each respective context data input in the plurality of context data inputs;
generate a command to control the portion of dimmable glass that includes the determined tint value; and
transmit the command to a dimming controller coupled to the portion of dimmable glass to control a tinting level of the portion of dimmable glass according to the determined tint value.

2. The control system of claim 1, wherein determining the tint value for the portion of dimmable glass includes determining, based on the location information for the vehicle, a regulation limiting an upper bound or lower bound of the determined tint value.

3. The control system of claim 2, wherein the regulation limits the tint value to a fixed value.

4. The control system of claim 1, wherein determining the tint value for the portion of dimmable glass is further based on dividing an intermediate tint value by a refinement factor, wherein the refinement factor is an integer value greater than one.

5. The control system of claim 1, wherein the ambient condition for the vehicle includes one or more of: a sun azimuth level and a sun intensity level.

6. The control system of claim 1, wherein the ambient condition for the vehicle includes one or more of: a temperature level and a humidity level.

7. The control system of claim 1, wherein the ambient condition for the vehicle includes a safety level determined based on the location information for the vehicle.

8. The control system of claim 1, wherein the ambient condition for the vehicle includes a time of day.

9. The control system of claim 1, wherein the ambient condition for the vehicle is retrieved from a sensor coupled to the vehicle, wherein the sensor includes at least one of: a thermometer, a hygrometer, a light level sensor, and a motion sensor.

10. The control system of claim 1, wherein the type information for the vehicle includes an indication of a number and configuration of a plurality of dimmable glass portions coupled to the vehicle.

11. The control system of claim 1, wherein the driving mode of the vehicle includes an indication of one or more of: a speed of the vehicle, a direction of travel of the vehicle, and an indication of whether the vehicle is moving forward or in reverse.

12. The control system of claim 1, wherein the user preference associated with the vehicle indicates an upper bound and a lower bound for the determined tint value.

13. The control system of claim 1, wherein a plurality of portions of dimmable glass are coupled to the vehicle, and wherein the memory further stores instructions to cause the control system to determine, based on the context data inputs, a respective tint value for each respective portion of dimmable glass coupled to the vehicle.

14. The control system of claim 13, wherein the generated command includes the respective tint value for each respective portion of dimmable glass.

15. The control system of claim 13, wherein the memory further stores instructions to generate and transmit a plurality of commands, wherein each respective command is associated with a respective portion of dimmable glass that includes the respective tint value for the respective portion of dimmable glass.

16. The control system of claim 13, wherein the plurality of portions of dimmable glass include a windshield, a front portion, and a back portion.

17. The control system of claim 16, wherein the front portion is a front driver-side portion, and the plurality of portions of dimmable glass further includes a front passenger-side portion.

18. The control system of claim 13, wherein a tint value for a first portion of dimmable glass from the plurality of portions of dimmable glass is different from a tint value for a second portion of dimmable glass from the plurality of portions of dimmable glass.

19. A dimming control system for a vehicle, the dimming control system comprising:
a processor; and
memory coupled to the processor and storing instructions that, when executed by the processor, cause the dimming control system to:
retrieve a plurality of context data inputs associated with the vehicle, wherein the context data inputs include location information for the vehicle and one or more of: type information for the vehicle, a driving mode of the vehicle, an ambient condition for the vehicle, and a user preference associated with the vehicle;
determine, based on the context data inputs, a tint value for a portion of dimmable glass coupled to the vehicle, wherein determining the tint value includes determining a respective weighted visible light transmission value for each respective context data input in the plurality of context data inputs; and
control a tinting level of the portion of dimmable glass according to the determined tint value.

20. A vehicle comprising:
a portion of dimmable glass; and
a dimming control system coupled to the portion of dimmable glass, the dimming control system comprising:
a processor; and
memory coupled to the processor and storing instructions that, when executed by the processor, cause the dimming control system to:
retrieve a plurality of context data inputs associated with the vehicle, wherein the context data inputs include location information for the vehicle and one or more of: type information for the vehicle, a driving mode of the vehicle, an ambient condition for the vehicle, and a user preference associated with the vehicle;
determine, based on the context data inputs, a tint value for the portion of dimmable glass, wherein determining the tint value includes determining a respective weighted visible light transmission value for each respective context data input in the plurality of context data inputs; and
control a tinting level of the portion of dimmable glass according to the determined tint value.
